(19) United States
(12) Patent Application Publication
(10) Pub. No.: US 2006/0222453 A1
(43) Pub. Date: Oct. 5, 2006

(54) Mounting clamp

(76) Inventor: Micha Plaschkes, Kibbutz Magen (IL)

Correspondence Address: SCHWEITZER CORNMAN GROSS & BONDELL LLP, 292 MADISON AVENUE - 19th FLOOR, NEW YORK, NY, 10017, US

(21) Appl. No.: 11/387,538

(22) Filed: Mar. 23, 2006

(30) Foreign Application Priority Data
Apr. 3, 2005 (IL) 167,823

(51) Int. Cl. F16D 1/12

(52) U.S. Cl. 403/110

(57) ABSTRACT

There is provided a clamp for securely attaching a component of a solar collector to a surface, including an upper clamp member and a lower clamp member. The lower member is fixedly mountable to the surfaces and the upper and lower clamp member are connectable to one another by locking members, defining between themselves an aperture for the accommodation of the component. The aperture has a length dimension and a height dimension, wherein the length dimension substantially exceeds the height dimension.

### FIELD OF THE INVENTION

The present invention relates to a mounting clamp for securely attaching solar collectors to roofs or other surfaces.

### BACKGROUND OF THE INVENTION

The subject solar collector is preferably a per-se known modular all-plastic solar collector consisting of units comprised of two spaced-apart tubular manifolds, i.e., an inlet manifold and an outlet manifold, interconnected by a plurality of spaced plastic tubulets which, collectively, constitute the active collecting surface of the solar collector.

Serious problems are encountered in securely attaching these collectors to their supporting surfaces such as tiled roofs or other flat surfaces, as the thermal longitudinal expansion and contraction of the tubulets and of the manifolds might be considerable and a rigid anchoring is therefore not acceptable, as this would produce impermissible strains and stressed in both the collector and the roof tiles.

### DISCLOSURE OF THE INVENTION

It is one of the objects of the present invention to provide a mounting clamp that facilitates the secure mounting of the above-mentioned solar collectors while permitting thermal-expansion and contraction produced movement of the collector compounds.

According to the present invention, this is achieved by providing a clamp for securely attaching a component of a solar collector to a surface, comprising an upper clamp member and a lower clamp member, said lower member being fixedly mountable to said surfaces; said upper and lower clamp member being connectable to one another by locking means, defining between themselves an aperture for the accommodation of said component, which aperture has a length dimension and a height dimension, characterized in that said length dimension substantially exceeds said height dimension.

### BRIEF DESCRIPTION OF THE DRAWINGS

The invention will now be described in connection with certain preferred embodiments with reference to the following illustrative figures so that it may be more fully understood.

With specific reference now to the figures in detail, it is stressed that the particulars shown are by way of example and for purpose of illustrative discussion of the preferred embodiments of the present invention only and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a schematic representation of a solar collector mounted on a slanting roof with the aid of clamps according to the present invention;

FIG. 2 shows the upper and lower clamp members as connected to one another;

FIG. 3 is a perspective view of the upper clamp member;

FIG. 4 is a perspective view of the lower clamp member;

FIG. 5 is a partial cross-section of the lower clamp member, showing the release lever;

FIG. 6 is a side view of the lower clamp member as seen in direction of arrow A in FIG. 5;

FIG. 7 is a partial top view of the upper clamp member;

FIG. 8 is an enlarged view, in cross-section along plane VIII-VIII in FIG. 7;

FIG. 9 is a partial bottom view of the upper clamp member;

FIG. 10 is a bottom view of the lower clamp member;

FIG. 11 is a perspective view of a pad for corrugated roofs, and

FIG. 12 is the pad of FIG. 11, as mounted in the clamp.

### DETAILED DESCRIPTION OF THE PREFERRED EMBODIMENTS

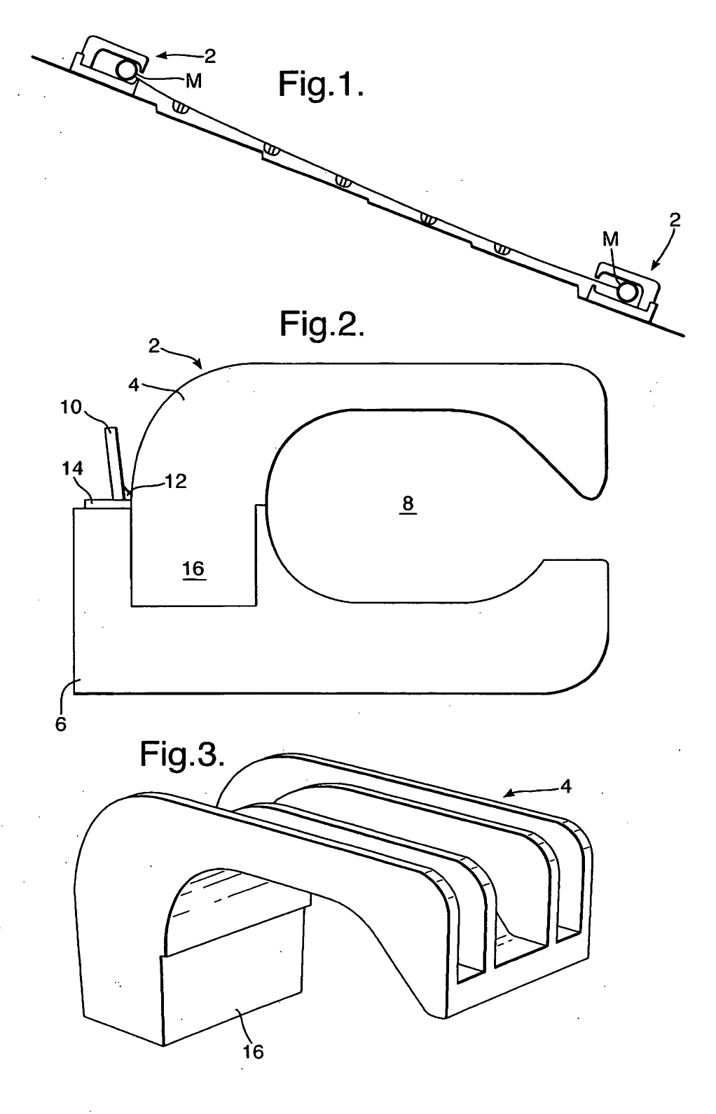

Referring now to the drawings there is seen in FIG. 1 a schematic representation of one of the above-mentioned solar collectors mounted on a slanting roof with the aid of the clamps according to the invention. There are shown two clamps 2, each accommodating and holding one of the manifolds M of the collector. It is clearly seen that the aperture in which the cylindrical manifolds M are seated has a height dimension and a length dimension, and that the length dimension exceeds the height dimension, so that the length dimension easily accommodates any changes in the manifold-to-manifold distance caused by thermal expansion and contraction.

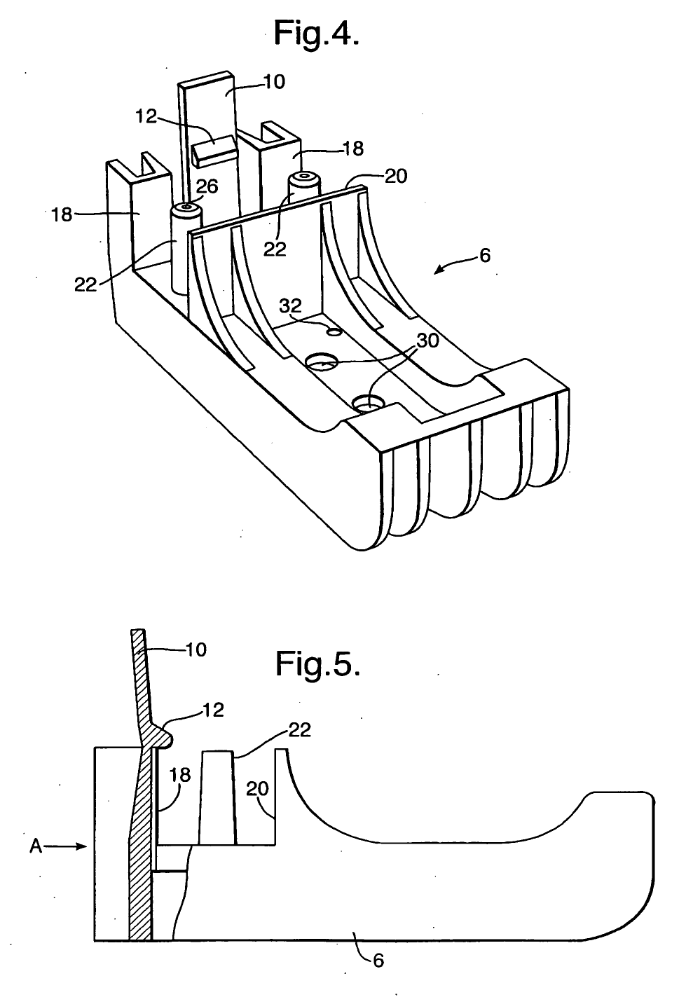

FIG. 2 clearly shows that clamp 2 is a two-part clamp, comprising an upper member 4 and a lower member 6, each of which is shown separately in FIGS. 3 and 4, respectively. When members 4 and 6 (FIG. 2) are connected (in a manner to be explained further below), they define between themselves an aperture 8, the height of which corresponds to the diameter of manifold M (FIG. 1), but the length of which, as is clearly seen, exceeds the height, to the effect explained above.

Further seen is the upper end of a release lever 10, part of a locking nose 12 and a guard railing 14 seen to better effect, and described in detail, in conjunction with FIGS. 5 to 8.

FIG. 4 depicts lower clamp member 6. There is seen release lever 10, advantageously an integral member of the injection-molded lower clamp member 6, as is locking nose 12.

Also shown in FIG. 4 are substantially parallel wall portions 18 and 20, between which is fittingly introduced leg portion 16 of upper clamp member 4. Introduction of leg portion 16 of member 4 is facilitated by two slightly tapering guide columns 22 which fit into appropriately dimensioned bores 24 seen in FIG. 9. For positive prevention of separation of members 4 and 6, holes 26 are provided in columns 22 into which screws can be driven through holes 28 in member 4 (FIGS. 7,8).

Further seen in FIG. 4 are two holes 30 of three (the third hole is hidden by wall 20) for bolts (not shown) to anchor member 6 to the roof. A plurality of smaller holes 32 facilitate the draining off of rain water.

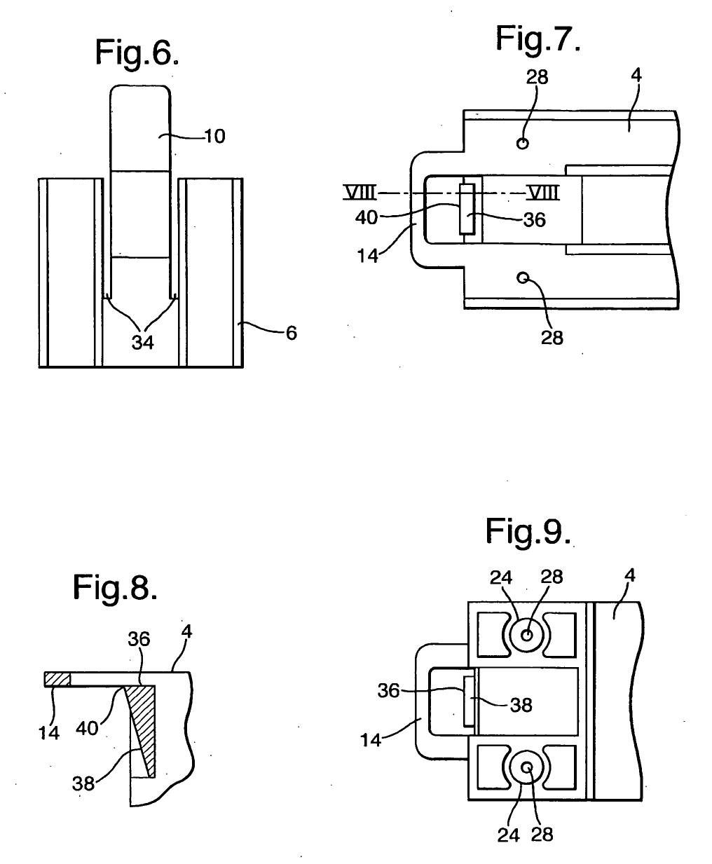

FIG. 5 shows release lever 10 and locking nose 12 in cross-section. Release lever 10 is rendered elastically deformable by the provision of long slots 34 seen in FIG. 6 which separate lever 10 from the rest of the molding.

FIG. 7 shows the locking lip 36 and the guard railing 14. When upper clamp member 4 is pressed down to connect it with lower clamp member 6, locking nose 12 (FIG. 5) is made to ride up an inclined plane 38, thereby flexing release lever 10 until, at the end of the ride, it jumps over edge 40 onto locking lip 36, constituting a rapid-action snap-in lock, preventing removal of upper clamp member 6. For removal, the protruding end of release lever 10 (FIG. 2) has to be pushed to the left, pulling locking nose 12 off locking lip 36. To protect release lever 10, its movement is limited by guard railing 14, so that the flexing of lever 10 remains within the elastic range.

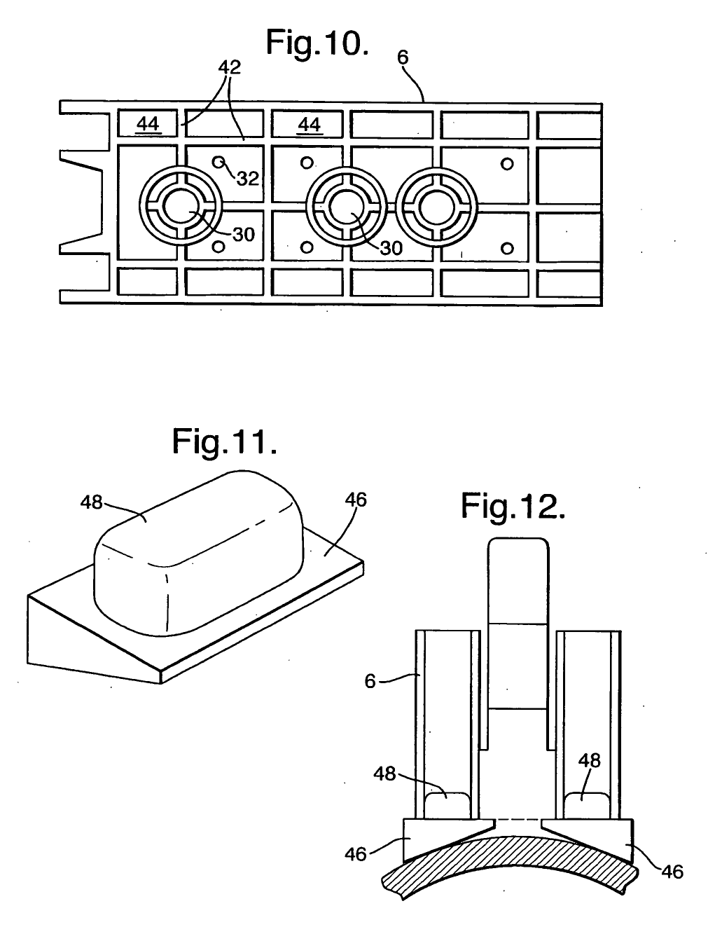

FIG. 10 is a bottom view of lower clamp member 6. Ribbing 42 serves not only for reinforcement, but also produces prismatic recesses 44 into which can be pushed rubber pads 46 having projections 48 such as those shown in FIGS. 11 and 12, which are suitable for corrugated roofs.

It will be evident to those skilled in the art that the invention is not limited to the details of the foregoing illustrated embodiments and that the present invention may be embodied in other specific forms without departing from the spirit or essential attributes thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

What is claimed is:

1. A clamp for securely attaching a component of a solar collector to a surface, comprising an upper clamp member and a lower clamp member, said lower member being fixedly mountable to said surfaces; said upper and lower clamp member being connectable to one another by locking means, defining between themselves an aperture for the accommodation of said component, which aperture has a length dimension and a height dimension,
characterized in that said length dimension substantially exceeds said height dimension.

2. The clamp as claimed in claim 1, wherein said locking means is a rapid-action snap-in lock comprised of a locking nose that is in an integral part of an elastically deformable release lever being a part of said lower clamp member, and a locking lip being a part of said upper clamp member.

3. The clamp as claimed in claim 1, further comprising a guard railing being part of said upper clamp member and preventing an excessive elastic deformation of said release lever.

4. The clamp as claimed in claim 1, further comprising at least one guide column being part of said lower clamp member and fitting at least one appropriately shaped mating part in said upper clamp member to facilitate the connection of said upper and lower clamp members.

5. The clamp as claimed in claim 4, wherein said at least one guide column in said lower clamp member is provided with a hole into which is screwed a screw, the head of which is supported in said upper clamp member.

6. The clamp as claimed in claim 1, wherein said lower clamp member comprises at least two holes for bolts to fixedly mount said lower clamp member on said surface.

7. The clamp as claimed in claim 1, wherein said lower clamp member comprises two spaced-apart wall members extending across said lower member into which space fits an appropriately shaped and dimensioned counter-parts of said upper clamp member.

8. The clamp as claimed in claim 1, wherein said lower clamp member comprises a number of holes for drainage of rain water.

9. The clamp as claimed in claim 1, further comprising elastically deformable pads carrying projections attachable to the underside of said lower clamp member, which pads have the shape of projections with slanting undersides, to facilitate the mounting of said clamp also on corrugated surfaces.
